(19) United States
(12) Patent Application Publication
(10) Pub. No.: US 2025/0097768 A1
(43) Pub. Date: Mar. 20, 2025

(54) ASSISTANCE INFORMATION FOR DISAGGREGATED NETWORK NODES

(71) Applicant: QUALCOMM Incorporated, San Diego, CA (US)

(72) Inventors: Toru UCHINO, Zushi-shi (JP); Prasad Reddy KADIRI, San Diego, CA (US); Bharat SHRESTHA, San Diego, CA (US); Umesh PHUYAL, San Diego, CA (US); Alberto RICO ALVARINO, San Diego, CA (US); Sitaramanjaneyulu KANAMARLAPUDI, San Diego, CA (US)

(21) Appl. No.: 18/468,155

(22) Filed: Sep. 15, 2023

(51) Int. Cl. H04W 28/06

(52) U.S. Cl. CPC H04W 28/06

(57) ABSTRACT

Various aspects of the present disclosure generally relate to wireless communication. In some aspects, a distributed unit (DU) of a network node may receive, from one or more of a user equipment (UE), a central unit (CU) of the network node, or another network node, assistance information, wherein the assistance information indicates one or more of: robust header compression (ROHC) feedback information, uplink data related information, packet reordering timer information, congestion related information, session control information, or radio resource control (RRC) message information. The DU may perform an action associated with the UE based at least in part on the assistance information. Numerous other aspects are described.

### FIELD OF THE DISCLOSURE

Aspects of the present disclosure generally relate to wireless communication and to techniques and apparatuses for assistance information for disaggregated network nodes.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a distributed unit (DU) of a network node includes one or more memories; and one or more processors coupled to the one or more memories, the one or more processors configured to: receive, from one or more of a user equipment (UE), a central unit (CU) of the network node, or another network node, assistance information, wherein the assistance information indicates one or more of: robust header compression (ROHC) feedback information, uplink data related information, packet reordering timer information, congestion related information, session control information, or radio resource control (RRC) message information; and perform an action associated with the UE based at least in part on the assistance information.

In some implementations, a method of wireless communication performed by a DU of a network node includes receiving, from one or more of a UE, a CU of the network node, or another network node, assistance information, wherein the assistance information indicates one or more of: ROHC information, uplink data related information, packet reordering timer information, congestion related information, session control information, or RRC message information; and performing an action associated with the UE based at least in part on the assistance information.

In some implementations, a non-transitory computer-readable medium storing a set of instructions for wireless communication includes one or more instructions that, when executed by one or more processors of a DU of a network node, cause the DU to: receive, from one or more of a UE, a CU of the network node, or another network node, assistance information, wherein the assistance information indicates one or more of: ROHC information, uplink data related information, packet reordering timer information, congestion related information, session control information, or RRC message information; and performing an action associated with the UE based at least in part on the assistance information.

In some implementations, an apparatus for wireless communication includes means for receiving, from one or more of a UE, a CU, or another network node, assistance information, wherein the assistance information indicates one or more of: ROHC information, uplink data related information, packet reordering timer information, congestion related information, session control information, or RRC message information; and performing an action associated with the UE based at least in part on the assistance information.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of robust header compression (ROHC), in accordance with the present disclosure.

FIG. 5 is a diagram illustrating an example of an ROHC behavior over a period of time, in accordance with the present disclosure.

FIG. 6 is a diagram illustrating an example of a central unit (CU) and distributed unit (DU) split in a network node, in accordance with the present disclosure.

FIG. 7 is a diagram illustrating an example of uplink voice packet signaling between a UE and an aggregated network node, in accordance with the present disclosure.

FIG. 8 is a diagram illustrating an example of uplink voice packet signaling between a UE and a disaggregated network node, in accordance with the present disclosure.

FIGS. 9-10 are diagrams illustrating examples associated with assistance information for disaggregated network nodes, in accordance with the present disclosure.

FIG. 11 is a diagram illustrating an example process associated with assistance information for disaggregated network nodes, in accordance with the present disclosure.

FIG. 12 is a diagram of an example apparatus for wireless communication, in accordance with the present disclosure.

### DETAILED DESCRIPTION

A robust header compression (ROHC) may involve compressing an Internet Protocol (IP) portion, a user datagram protocol (UDP) portion, and a real-time transport protocol (RTP) portion of a header. An ROHC header may be an ROHC compressed IP/UDP/RTP header. A packet may be associated with the ROHC header and a payload. For the packet, a network node (e.g., a gNB) may provide an uplink grant that fits to a MAC service data unit (SDU) size as much as possible. An over-allocated transport block size (TBS) may cause less resource efficiency and/or less uplink coverage, whereas an under-allocated TBS may cause less resource efficiency (split loss) and/or more packet transmission delay. The network node may determine a TBS based at least in part on ROHC activities. For example, when the network node transmits an ROHC negative acknowledgement (NACK) in a downlink direction, the network node may provide a larger TBS based at least in part on a prediction that the UE will transmit a next uplink packet with a larger ROHC header for ROHC context resynchronization.

However, in some cases, the network node may be a disaggregated network node. For example, the network node may be a split central unit (CU) and distributed unit (DU) gNB (CU-DU gNB). In a CU-DU split, an ROHC function and a scheduling function may be located in separate nodes, and thus, a scheduler may be unable to determine the TBS based at least in part on the ROHC activities. For example, the ROHC may be located in a CU, whereas a scheduling function may be located in a DU. The scheduling function at the DU may be unable to determine the TBS based at least in part on the ROHC activities, because the ROHC may be located in the CU. As a result, the TBS may not be based at least in part on the ROHC activities, which may increase a likelihood that the uplink grant does not fit to the MAC SDU size. When the uplink grant does not fit to the MAC SDU size, the TBS may be over-allocated, which may result in less resource efficiency and/or less uplink coverage, or the TBS may be under-allocated, which may result in less resource efficiency and/or more packet transmission delay.

Various aspects relate generally to assistance information for disaggregated network nodes. Some aspects more specifically relate to assistance information including ROHC information for a DU associated with a network node. In some examples, the DU may receive, from a UE and/or a CU associated with the network node, assistance information. The assistance information may indicate the ROHC information. The ROHC information may indicate a feedback type, such as an acknowledgement (ACK) or a negative acknowledgement (NACK). The DU may perform an action associated with the UE based at least in part on the ROHC information. For example, when performing the action, the DU may transmit, to the UE, an uplink grant indicating a TBS associated with a first header packet, in relation to an uplink grant indicating a TBS associated with a second header packet, based at least in part on the ROHC information. The TBS associated with the first header format may be larger than the TBS associated with the second header packet.

Particular aspects of the subject matter described in this disclosure can be implemented to realize one or more of the following potential advantages. In some examples, by providing assistance information to the DU, the described techniques can be used to reduce excess signaling and/or reduce a delay associated with the excess signaling. Since a scheduling function may be associated with the DU and an ROHC function may be associated with the CU, the CU may provide the ROHC information to the DU, which may enable the DU to perform the scheduling function based at least in part on the ROHC information associated with the ROHC function. As a result, the scheduling function associated with the DU may determine a TBS for scheduling based at least in part on ROHC activities, thereby improving an overall system performance. On the other hand, when the DU performs the scheduling without the ROHC information, the DU may not determine a suitable TBS for scheduling, which may cause additional packets and/or uplink grants to be transmitted between the UE, the DU, and/or the CU. The additional packets and/or uplink grants may cause excess signaling and/or delay associated with the excess signaling. Thus, an ability to share the ROHC information between the CU and the DU may improve the overall system performance.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

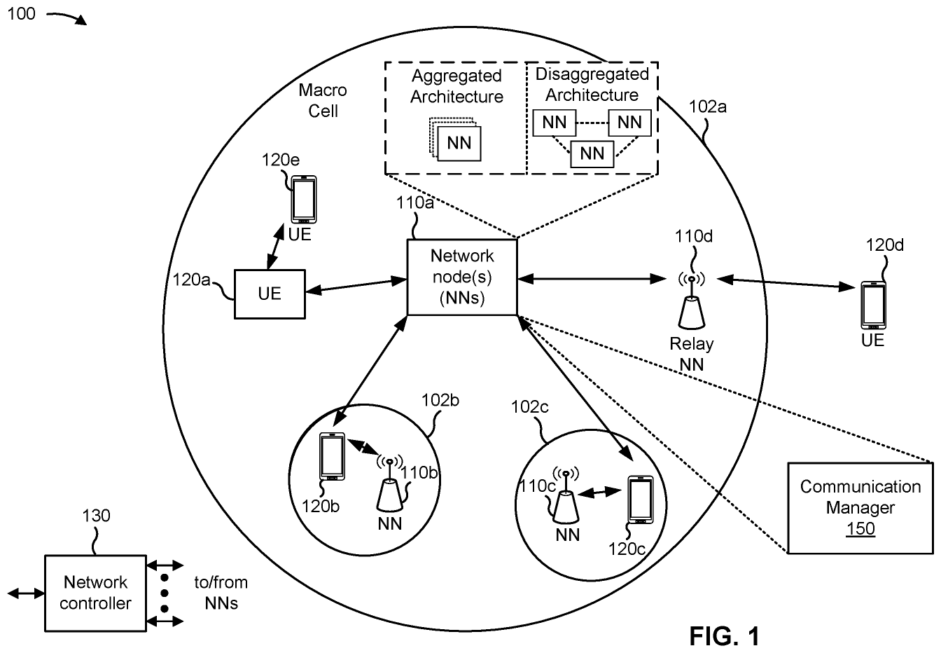

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more CUs, one or more DUs, or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a DU (e.g., the network node 110) may include a communication manager 150. As described in more detail elsewhere herein, the communication manager 150 may receive, from one or more of a UE, a CU, or another network node, assistance information, wherein the assistance information indicates one or more of: ROHC information, uplink data related information, packet reordering timer information, congestion related information, session control information, or RRC message information; and performing an action associated with the UE based at least in part on the assistance information. Additionally, or alternatively, the communication manager 150 may perform one or more other operations described herein.

As indicated above, FIG. 1 is provided as an example. Other examples may differ from what is described with regard to FIG. 1.

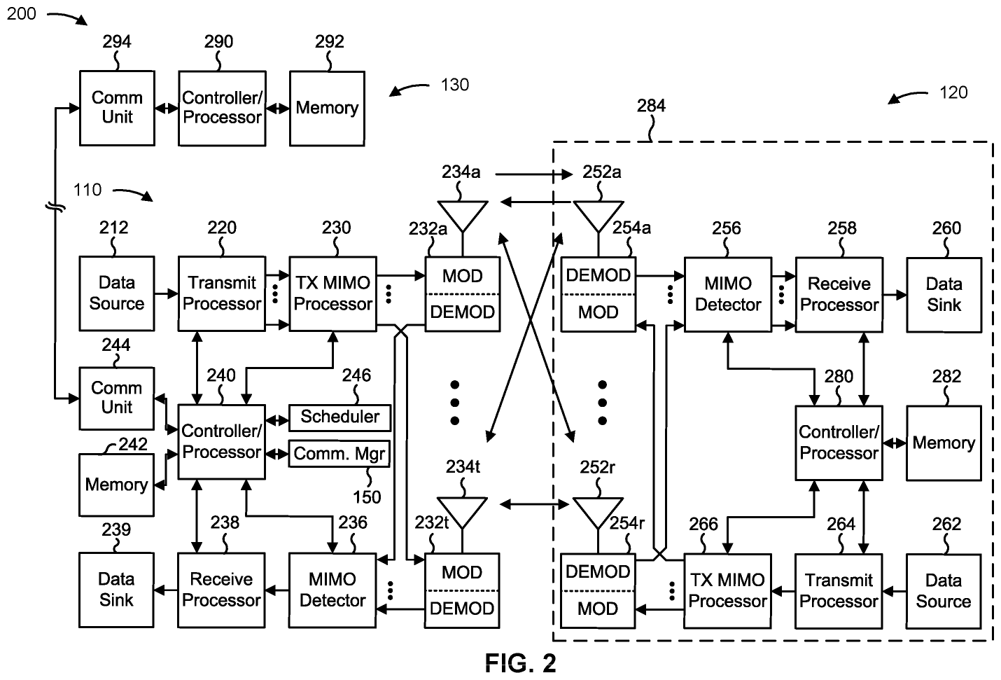

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

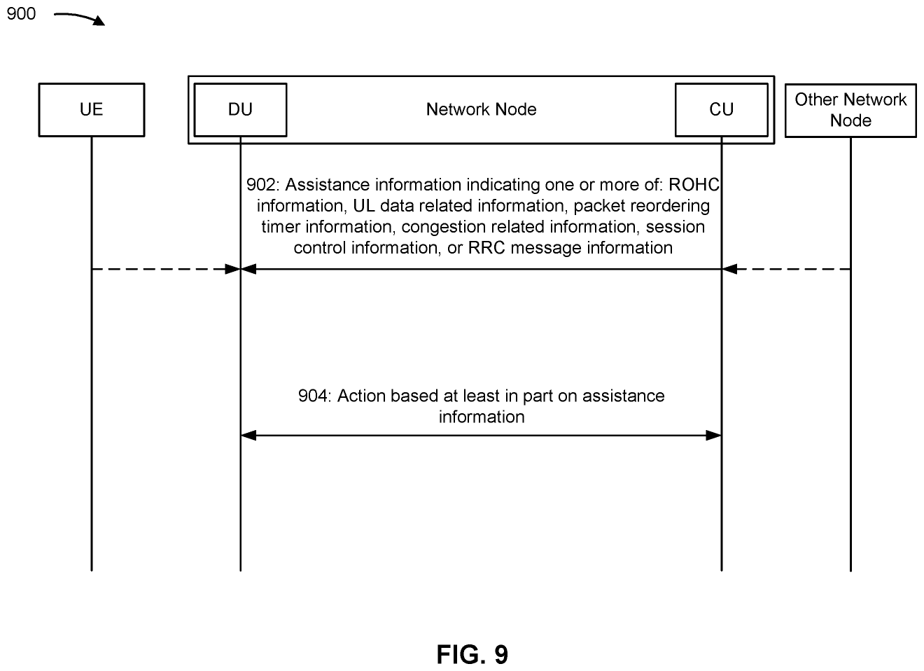

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 9-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 9-12).

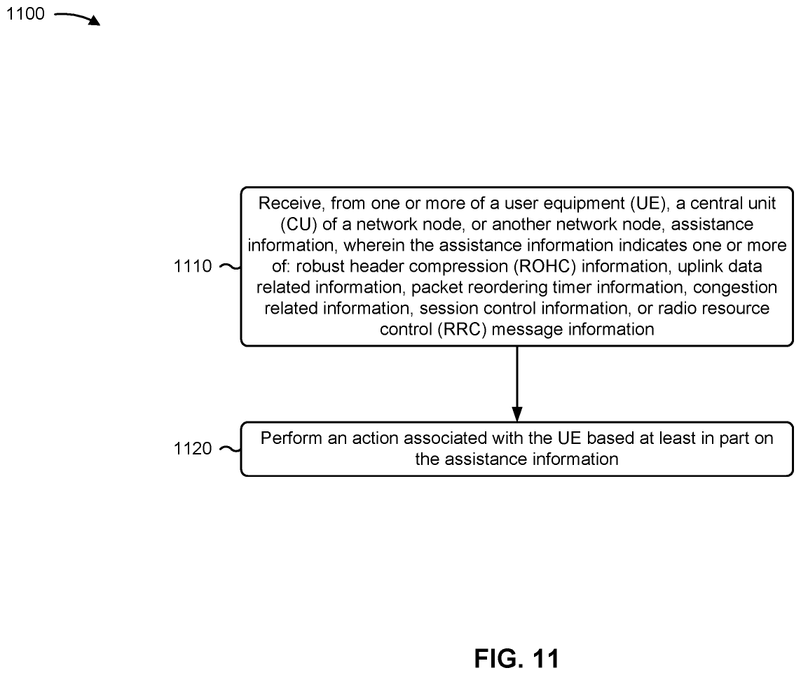

The controller/processor 240 of the network node 110, the controller/processor 280 of the UE 120, and/or any other component(s) of FIG. 2 may perform one or more techniques associated with assistance information for disaggregated network nodes, as described in more detail elsewhere herein. For example, the controller/processor 240 of the network node 110, the controller/processor 280 of the UE 120, and/or any other component(s) of FIG. 2 may perform or direct operations of, for example, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, and/or other processes as described herein. In some examples, executing instructions may include running the instructions, converting the instructions, compiling the instructions, and/or interpreting the instructions, among other examples.

In some aspects, a DU of a network node (e.g., the network node 110) includes means for receiving, from one or more of a UE, a CU, or another network node, assistance information, wherein the assistance information indicates one or more of: ROHC information, uplink data related information, packet reordering timer information, congestion related information, session control information, or RRC message information; and/or performing an action associated with the UE based at least in part on the assistance information. In some aspects, the means for the DU to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

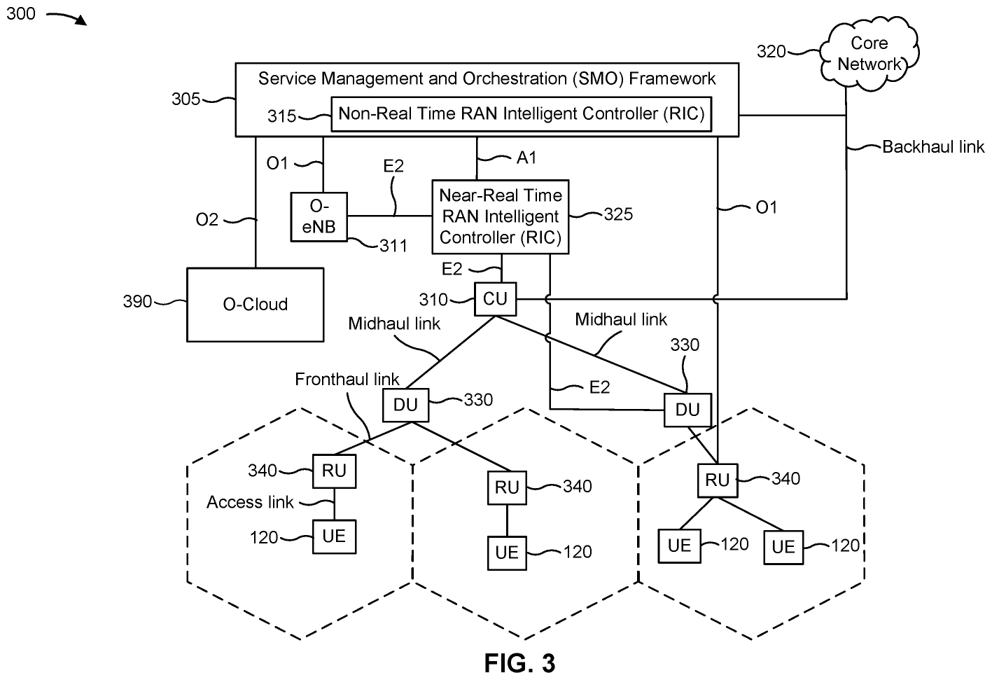

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

A PDCP layer may support ROHC, which may be used for relatively small packets, such as voice packets. An ROHC compressed IP/UDP/RTP header may be based at least in part on static header content (e.g., an IP address and/or a UDP port) and dynamic header content (e.g., an RTP sequence number (SN) and/or an RTP timestamp). A compressor may first transmit a packet with a full header, which may be used by a decompressor to establish an ROHC context, which may include a static part and a dynamic part (e.g., an initial RTP SN value and/or an RTP time stamp delta). The dynamic part may be indicated based at least in part on a delta value. After the ROHC context is established, the compressor may transmit a compressed ROHC header, which may be 3 bytes at minimum. The compressor may temporarily enlarge an ROHC header size based at least in part on a detection that an ROHC context update or resynchronization is needed.

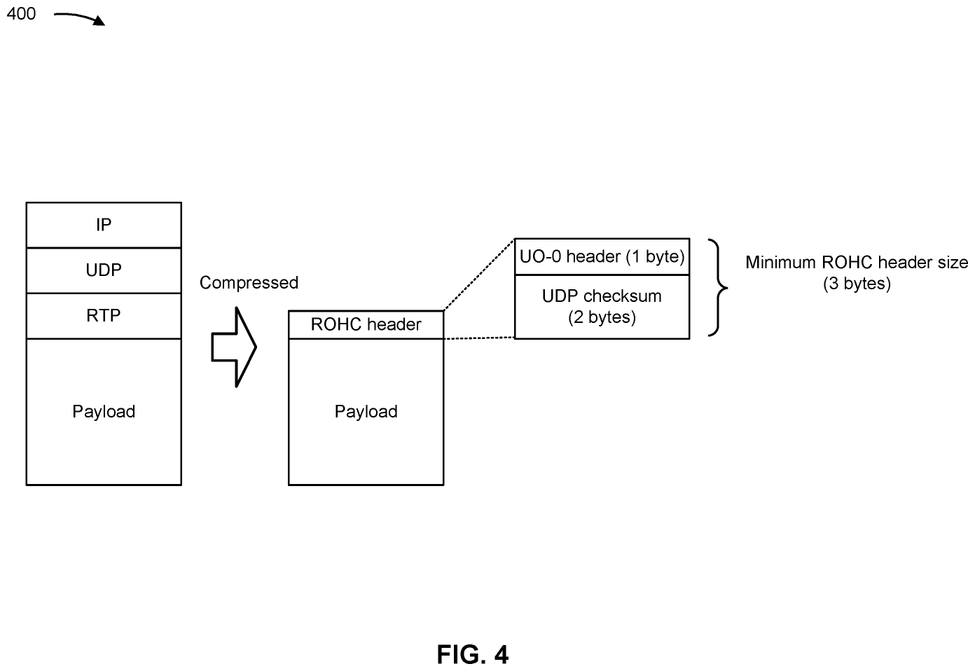

FIG. 4 is a diagram illustrating an example 400 of ROHC, in accordance with the present disclosure.

As shown in FIG. 4, a header may include an IP part, a UDP part, an RTP part, and a payload. The IP part, the UDP part, and the RTP part may be compressed to form an ROHC header. The ROHC header may be an ROHC compressed IP/UDP/RTP header. The payload may not be changed. The ROHC header may include a header (e.g., UO-0 header), which may be 1 byte. The ROHC header may include a UDP checksum, which may be 2 bytes. Thus, a minimum ROHC header size may be 3 bytes.

As indicated above, FIG. 4 is provided as an example. Other examples may differ from what is described with regard to FIG. 4.

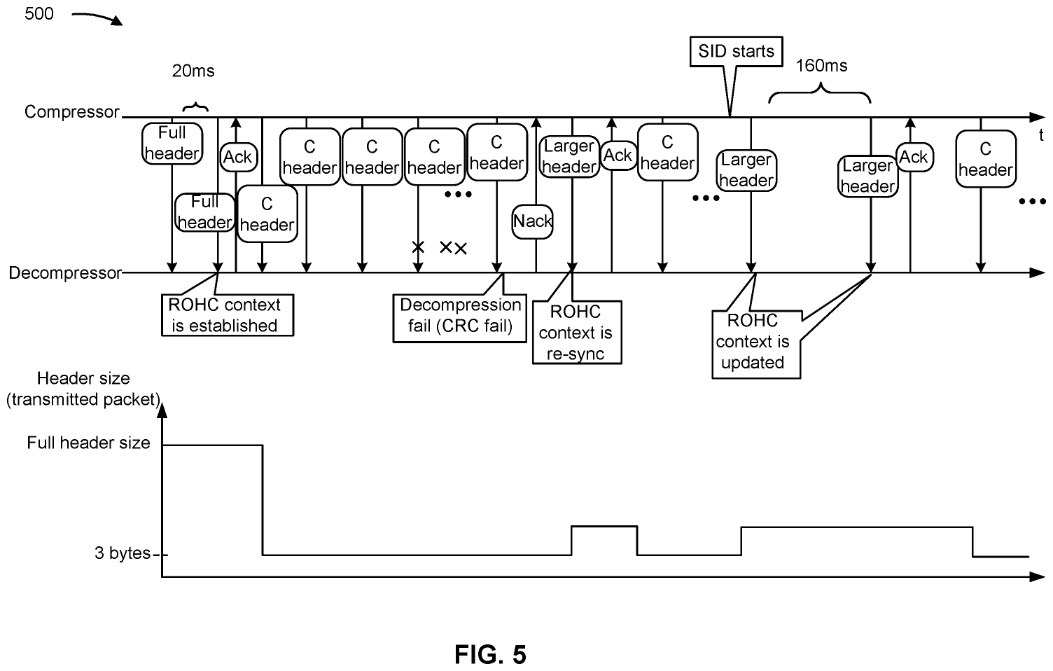

FIG. 5 is a diagram illustrating an example 500 of an ROHC behavior over a period of time, in accordance with the present disclosure.

As shown in FIG. 5, a compressor may transmit multiple full headers to a decompressor, which may serve to establish an ROHC context. The decompressor may transmit an acknowledgement (ACK) to the compressor. After the ROHC context is established, the compressor may transmit one or more compressed (C) headers to the decompressor. A compressed header may be associated with a minimum ROHC header size (e.g., 3 bytes). At a later point in time, the decompressor may determine that a decompression fails (e.g., due to a cyclic redundancy check (CRC) failure), which may cause the decompressor to transmit a NACK to the compressor. When the ROHC context is being resynchronized, the compressor may transmit a relatively larger packet, in relation to the compressed packet, to the decompressor. The decompressor may transmit an ACK to the compressor, which may be based at least in part on the ROHC context resynchronization being successful. After the successful ROHC context resynchronization, the compressor may transmit one or more compressed headers to the decompressor. At a later point in time, an ROHC context may be updated, during which the compressor may transmit the relatively larger packet to the decompressor. After the ROHC context is successfully updated, the compressor may resume transmitting compressed headers to the decompressor.

As indicated above, FIG. 5 is provided as an example. Other examples may differ from what is described with regard to FIG. 5.

An ROHC behavior may utilize the nature of header contents in voice. In a compressed ROHC header, some fields may be static (e.g., an IP address and/or a UDP port) and other fields may change with a predictable pattern (e.g., an RTP SN and/or an RTP timestamp). After a compressor and a decompressor have established an ROHC context, only a relatively small amount of information may need to be transmitted over the air, which may be based at least in part on an assumption that un-transmitted parts of the compressed ROHC header may be derived from stored ROHC context. The ROHC context may include header information (e.g., a static part and information to derive an original value of a dynamic part, such as an offset and a delta). The ROHC context may be created and maintained per a combination of static parts (e.g., IP address, UDP port number, and/or a synchronization source (SSRC)). Thus, one PDCP entity may maintain multiple ROHC contexts, which may each be uniquely identified by a context ID (CID).

The compressor may transmit several packets with a full header to establish the ROHC context at the decompressor. After the compressor confirms an ROHC context establishment in the decompressor, which may be based at least in part on a certain number of full header packets being transmitted to the decompressor or an ACK being received from the decompressor, the compressor may start to transmit packets with a compressed ROHC header. The compressor may use a larger size header, relative to the compressed ROHC header, when an update or a resynchronization of the ROHC context is needed. When an ROHC context mismatch is detected by the decompressor (e.g., a CRC fails) due to a bulk packet loss, the decompressor may feedback a NACK to the compressor, which may cause the compressor to transmit a packet with the larger-size header (or even a full-size header) to re-synchronize the ROHC context. When the ROHC context needs to be updated (e.g., at a beginning of a talk spurt), the compressor may use the larger-size header to update the ROHC context at the decompressor. For example, a pitch of an RTP time stamp may be changed for a static IP identifier (SID) compared with a voice packet.

A network node (e.g., a gNB) may be associated with a CU-DU split. The CU-DU split in the network node may be due to an increased requirement of a fronthaul bandwidth (e.g., due to a relatively large bandwidth and massive MIMO in a 5G system) in a centralized RAN (C-RAN) deployment. An RLC layer and lower layer may be located in a gNB distributed unit (DU). A PDCP layer and higher layers may be located in a gNB central unit (CU). An open interface may be defined between the CU and the DU.

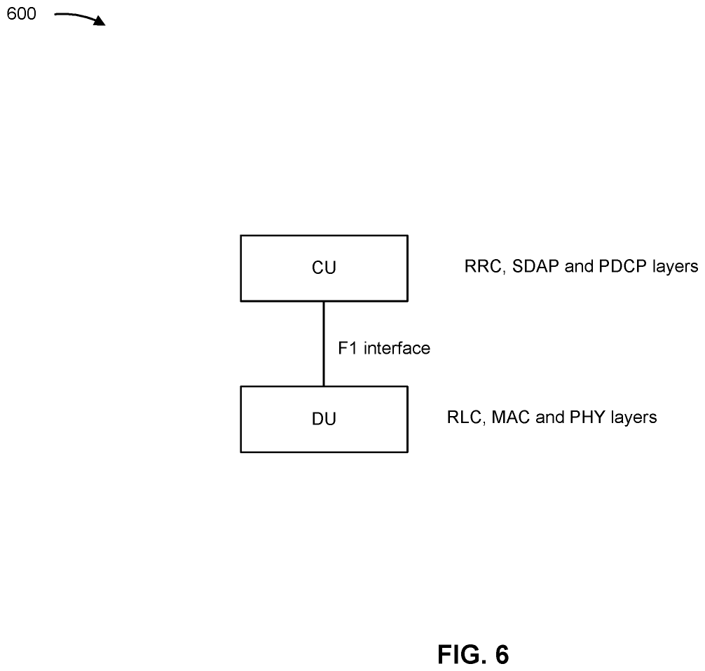

FIG. 6 is a diagram illustrating an example 600 of a CU and DU split in a network node, in accordance with the present disclosure.

As shown in FIG. 6, a CU may be connected to a DU via an F1 interface. The CU may be associated with an RLC layer, an SDAP layer, and a PDCP layer. The DU may be associated with an RLC layer, a MAC layer, and a PHY layer.

As indicated above, FIG. 6 is provided as an example. Other examples may differ from what is described with regard to FIG. 6.

For a relatively small packet, an uplink grant may be provided to fit to a MAC SDU size as much as possible. An over-allocated TBS may cause less resource efficiency and/or less uplink coverage, whereas an under-allocated TBS may cause less resource efficiency (split loss) and/or more packet transmission delay due to an RLC segmentation. A network node may determine a TBS based at least in part on ROHC activities. For example, when a network node transmits an ROHC NACK in a downlink direction, the network node may provide a larger TBS based at least in part on a prediction that the UE will transmit a next uplink packet with a larger ROHC header for ROHC context resynchronization. However, in a CU-DU split, an ROHC function and a scheduling function may be located in separate nodes, and thus, a scheduler may be unable to determine the TBS based at least in part on the ROHC activities. For example, the ROHC may be located in a CU, whereas a scheduling function may be located in a DU. The scheduling function at the DU may be unable to determine the TBS based at least in part on the ROHC activities because the ROHC may be located in the CU. As a result, the TBS may not be based at least in part on the ROHC activities, which may increase a likelihood that the uplink grant does not fit to the MAC SDU size. When the uplink grant does not fit to the MAC SDU size, the TBS may be over-allocated, which may result in less resource efficiency and/or less uplink coverage, or the TBS may be under-allocated, which may result in less resource efficiency and/or more packet transmission delay.

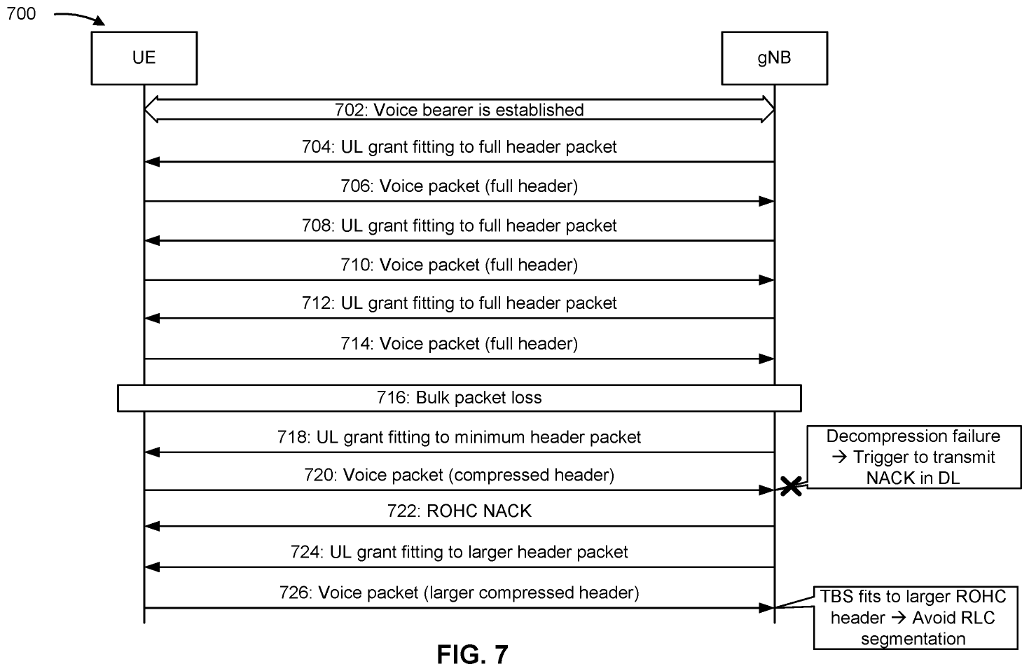

FIG. 7 is a diagram illustrating an example 700 of uplink voice packet signaling between a UE and an aggregated network node, in accordance with the present disclosure. As shown in FIG. 7, example 700 includes communication between the UE (e.g., UE 120) and the aggregated network node (e.g., network node 110). In some aspects, the UE and the aggregated network node may be included in a wireless network, such as wireless network 100. The aggregated network node may be a gNB.

As shown by reference number 702, a voice bearer may be established between the UE and the gNB. As shown by reference number 704, the gNB may transmit, to the UE, an uplink grant fitting to a full header packet. As shown by reference number 706, the UE may transmit, to the gNB, a voice packet with a full header. As shown by reference number 708, the gNB may transmit, to the UE, an uplink grant fitting to a full header packet. As shown by reference number 710, the UE may transmit, to the gNB, a voice packet with a full header. As shown by reference number 712, the gNB may transmit, to the UE, an uplink grant fitting to a minimum header packet. As shown by reference number 714, the UE may transmit, to the gNB, a voice packet with a compressed header.

As shown by reference number 716, a bulk packet loss may occur between the UE and the gNB. As shown by reference number 718, the gNB may transmit, to the UE, an uplink grant fitting to a minimum header packet. As shown by reference number 720, the UE may transmit, to the gNB, a voice packet with a compressed header. The gNB may experience a decompression failure, which may cause the gNB to be unable to decompress the compressed header. The decompression failure may trigger the gNB to transmit a NACK in a downlink direction. As shown by reference number 722, the gNB may transmit, to the UE, an ROHC NACK. As shown by reference number 724, the gNB may transmit, to the UE, an uplink grant fitting to a larger header packet, in relation to the minimum header packet. As shown by reference number 726, the UE may transmit, to the gNB, a voice packet with a larger compressed header, in relation to the compressed header. A TBS may fit to a larger ROHC header, which may avoid an RLC segmentation.

As indicated above, FIG. 7 is provided as an example. Other examples may differ from what is described with regard to FIG. 7.

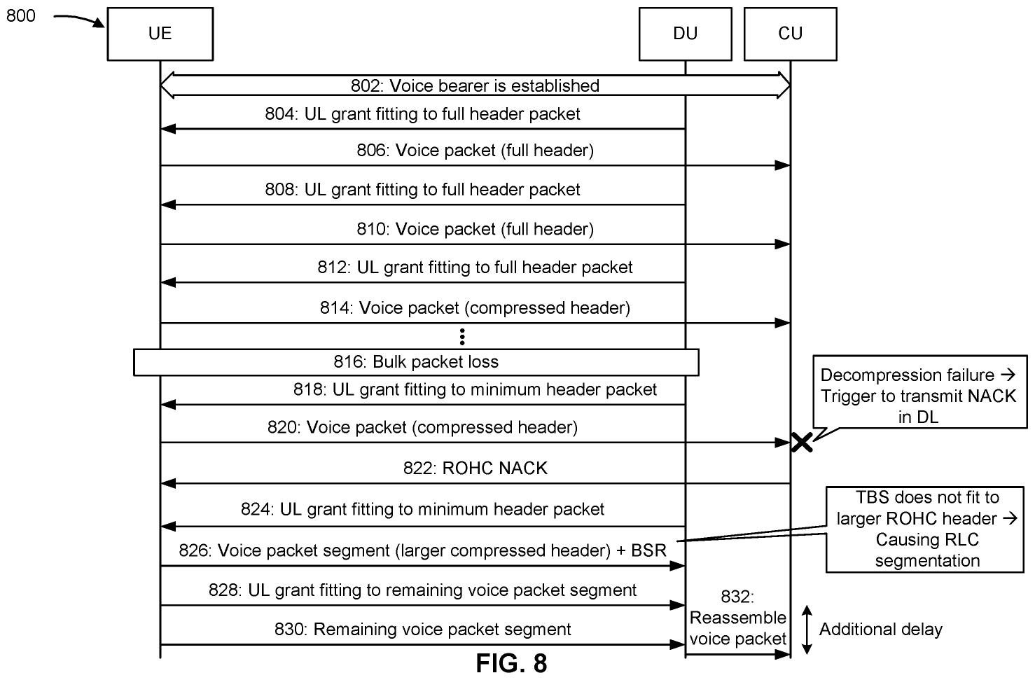

FIG. 8 is a diagram illustrating an example 800 of uplink voice packet signaling between a UE and a network node, in accordance with the present disclosure. As shown in FIG. 8, example 800 includes communication between the UE (e.g., UE 120) and the network node (e.g., network node 110). In some aspects, the UE and the network node may be included in a wireless network, such as wireless network 100. The network node may be a CU-DU split gNB. For example, the network node may include a DU and a CU.

As shown by reference number 802, a voice bearer may be established between the UE and the CU. As shown by reference number 804, the DU may transmit, to the UE, an uplink grant fitting to a full header packet. As shown by reference number 806, the UE may transmit, to the CU, a voice packet with a full header. As shown by reference number 808, the DU may transmit, to the UE, an uplink grant fitting to a full header packet. As shown by reference number 810, the UE may transmit, to the CU, a voice packet with a full header. As shown by reference number 812, the DU may transmit, to the UE, an uplink grant fitting to a minimum header packet. As shown by reference number 814, the UE may transmit, to the CU, a voice packet with a compressed header.

As shown by reference number 816, a bulk packet loss may occur between the UE and the DU. As shown by reference number 818, the DU may transmit, to the UE, an uplink grant fitting to a minimum header packet. As shown by reference number 820, the UE may transmit, to the CU, a voice packet with a compressed header. The CU may experience a decompression failure, which may cause the CU to be unable to decompress the compressed header. The decompression failure may trigger the CU to transmit a NACK in a downlink direction. As shown by reference number 822, the CU may transmit, to the UE, an ROHC NACK. As shown by reference number 824, the DU may transmit, to the UE, an uplink grant fitting to a minimum header packet (e.g., not fitting to a larger header packet), which may be due to the CU transmitting the ROHC NACK but the DU transmitting the uplink grant.

As shown by reference number 826, the UE may transmit, to the DU, a voice packet segment with a larger compressed header, in relation to the compressed header, and a buffer status report (BSR). A TBS may not fit to a larger ROHC header, which may cause an RLC segmentation. As shown by reference number 828, the DU may transmit, to the UE, an uplink grant fitting to a remaining voice packet segment. As shown by reference number 830, the UE may transmit, to the DU, a remaining voice packet segment. As shown by reference number 832, the DU may transmit, to the CU, a reassembled voice packet. The reassembled voice packet may be based at least in part on the voice packet segment with the larger compressed header and the remaining voice packet segment. An additional delay may occur when the DU transmits the uplink grant fitting to the remaining voice packet segment, the UE transmits the remaining voice packet segment, and the DU transmits the reassembled voice packet. The additional delay, as well as increased signaling, may degrade an overall system performance.

As indicated above, FIG. 8 is provided as an example. Other examples may differ from what is described with regard to FIG. 8.

In various aspects of techniques and apparatuses described herein, a DU may receive, from a UE and/or a CU associated with the network node, assistance information. The assistance information may indicate the ROHC information. The ROHC information may indicate a feedback type, such as an ACK or a NACK. The DU may perform an action associated with the UE based at least in part on the ROHC information. For example, when performing the action, the DU may transmit, to the UE, an uplink grant indicating a TBS associated with a first header packet, in relation to an uplink grant indicating a TBS associated with a second header packet, based at least in part on the ROHC information. The TBS associated with the first header format may be larger than the TBS associated with the second header packet.

In some aspects, the DU may be provided with information related to ROHC activities. For example, the CU and/or the UE may provide, to the DU, the information related to ROHC activities. The information may include candidate information. The candidate information may include ROHC information, such as ACK information, NACK information, and/or static NACK information. The candidate information may include ROHC parameter information.

For example, when a decompression failure occurs at the CU and the CU transmits an ROHC NACK to the UE, the UE and/or the CU may indicate the ROHC NACK to the DU. Based at least in part on the indication of the ROHC NACK, the DU may transmit, to the UE, an uplink grant fitting to a larger header packet. The DU may transmit the uplink grant fitting to the larger header packet instead of an uplink grant fitting to a minimum header packet. The UE may be able to transmit a voice packet with a larger compressed header. Otherwise, the UE may need to transmit a voice packet segment with a larger compressed header, and then need to transmit a remaining voice packet segment, where such RLC segmentation may cause additional delay. As a result, an ability for the CU and/or the UE to provide, to the DU, the information related to ROHC activities may improve an overall system performance.

In some aspects, in addition to ROHC, an ability for the CU and/or the UE to indicate assistance information to the DU may be applicable to various other scenarios. For example, the assistance information to the DU may apply to extended reality (XR) traffic cases, in which a periodic intra-frame (I-frame) model may be based at least in part on packet failures known to the CU or from upper layers behind the CU. A PDCP reordering timer expiry may result in downlink packet loss, which may result in application feedback pushing the UE to transmit a more frequent I-frame needing higher radio resources. The assistance information to the DU may apply to cases in which a PDCP reordering timer is expiring. A PDCP layer may request for a higher grant at the DU to recover an RLC level retransmission. The PDCP layer may request a higher grant to the UE in an uplink direction, which may occur when an upper layer indicates packet loss at a transmission control protocol (TCP) level due to a UE PDCP discard timer expiry. The PDCP layer may request the higher grant to the UE in the uplink direction, which may occur when a TCP layer is recovering a packet loss.

FIG. 9 is a diagram illustrating an example 900 associated with assistance information for disaggregated network nodes, in accordance with the present disclosure. As shown in FIG. 9, example 900 includes communication between a UE (e.g., UE 120) and a network node (e.g., network node 110). In some aspects, the UE and the network node may be included in a wireless network, such as wireless network 100. The network node may be associated with a DU and a CU.

As shown by reference number 902, the DU may receive, from the UE, the CU, and/or another network node, assistance information. The assistance information may indicate ROHC information. The assistance information may indicate uplink data related information. The assistance information may indicate packet reordering timer information. The assistance information may indicate congestion related information. The assistance information may indicate session control information. The assistance information may indicate RRC message information.

As shown by reference number 904, the DU may perform an action associated with the UE based at least in part on the assistance information. For example, the DU may perform the action based at least in part on the ROHC information, the uplink data related information, the packet reordering timer information, the congestion related information, the session control information, and/or the RRC message information.

In some aspects, the ROHC information may indicate a feedback type, which may include an ACK or a NACK. In other words, the ROHC information may be ROHC feedback information. The ROHC information may indicate UE related identity information associated with the UE. The ROHC information may indicate whether downlink data is a PDCP data packet data unit (PDU) or a PDCP control PDU. The ROHC information may indicate a PDCP control PDU type when the downlink data is the PDCP control PDU. The ROHC information may indicate a timestamp, an indication of whether an uplink packet size will change, an expected uplink packet size, a difference of the uplink packet size from a previous uplink packet size, and/or a recommended TBS. The ROHC information may be associated with an NR user plane PDU format. The ROHC information may indicate a number of packets transmitted with a specific ROHC header. The specific ROHC header may be associated with an uncompressed packet, an initialization and refresh (IR) packet, an IR dynamic (IR-DYN) packet, or an ROHC header having a size that is greater than or equal to a threshold. The ROHC information may indicate a time period associated with the number of packets transmitted with the full ROHC header. The ROHC information may indicate an indication of an applicability to an initial ROHC context establishment, an ROHC context update, an ROHC context resynchronization, or an ROHC context repair. The ROHC information may be associated with a voice packet or a non-voice packet configured with ROHC.

In some aspects, the DU may receive, during a bearer setup procedure with the CU, a configuration associated with receiving the ROHC information. In some aspects, when performing the action, the DU may transmit, to the UE, an uplink grant indicating a TBS associated with a first header packet, in relation to an uplink grant indicating a TBS associated with a second header packet, based at least in part on the ROHC information. The TBS associated with the first header format may be larger than the TBS associated with the second header packet.

In some aspects, the DU may receive the ROHC information from the UE. The DU may receive the ROHC information in a periodic manner or in an event triggered manner. The UE may signal the ROHC information in accordance with a prohibit timer. In some aspects, the DU may receive the ROHC information from the CU. The ROHC information may include static information. The ROHC information may also include dynamic information associated with a UE uplink ROHC behavior, where the dynamic information may be received in a periodic manner or in an event triggered manner.

In some aspects, the assistance information may indicate an identification of a stream, a UE identifier (ID), a flow ID, a bearer ID, an RLC entity ID, an RLC channel ID, an RLC bearer ID, and/or a logical channel ID. The assistance information may indicate a cause value associated with an expected expiry of a PDCP reordering timer. The assistance information may indicate a request for additional uplink resources.

In some aspects, the assistance information may be provided to the DU for better scheduling with respect to an ROHC behavior. However, providing the assistance information to the DU for better scheduling may be extended to other upper layer behaviors (e.g., any upper layers above an RLC layer). For example, the other upper layer behaviors may be associated with multimedia traffic, a fast RLC retransmission to avoid a PDCP reordering timer expiry, a TCP packet drop, an application start phase, and/or an uplink RRC message.

In some aspects, the DU may receive the uplink data related information from the CU or the other network node. The uplink data related information may indicate an expected periodicity of uplink data, an expected uplink data size, and/or a period of change to a periodicity of uplink data. The uplink data related information may be associated with multimedia traffic. The DU, when performing the action, may receive uplink data from the UE based at least in part on the uplink data related information.

In some aspects, with respect to multimedia traffic, in a multimedia service (e.g., an extended reality (XR) service), several types of pictures/frames may be used, such as an I-frame and a predicted frame (P-frame). An I-frame may have a complete picture/frame and may be transmitted periodically. A P-frame may only have a delta from a previous picture/frame and thus may save overhead. When a receiving side cannot receive an I-frame, a decoder may be unable to decode data with subsequent P-frames. Thus, a transmission periodicity of the P-frame may be changed based at least in part on the situation at the receiving side; for example, a shorter periodicity may be used when an I-frame was dropped, which may be achieved based at least in part on feedback in upper layers (e.g., an application layer).

In some aspects, assistance information may be used for multimedia traffic. When the I-frame is dropped in an uplink direction, an upper layer in the UE may be expected to use a shorter periodicity for the I-frame based at least in part on feedback received in a downlink direction. Thus, the DU may be notified, via the assistance information, that a periodicity of an uplink occurrence may be changed (e.g., shorter, longer, or no change). The assistance information may be provided, to the DU, by the CU, and may be based at least in part on detecting a PDCP t-reordering expiry or an explicit indication from the UE of a PDCP discarding, or by another network node (e.g., an application server). The assistance information may indicate the identification of the stream, the UE ID, the flow ID, the bearer ID, an RLC entity/channel/bearer ID, and/or a logical channel ID. The assistance information may indicate the expected periodicity of uplink data, the expected uplink data size, and/or an expected period of change. The assistance information may indicate the cause value (e.g., a PDCP t-reordering expiry).

In some aspects, when performing the action, the DU may control a scheduling for the UE, a bearer, or a logical channel based at least in part on the packet reordering timer information. The packet reordering timer information may be associated with an RLC retransmission to avoid an expiry of a PDCP reordering timer. In some aspects, the DU may receive the packet reordering timer information from the CU. The packet reordering timer information may include a PDCP reordering timer value used by the CU. The DU, when performing the action, may maintain a PDCP reordering timer status based at least in part on a received uplink PDCP PDU. The DU may provide uplink resources for the UE, the bearer, or the logical channel based at least in part on an expected expiry of the PDCP reordering timer. The DU may trigger an RLC status report transmission to request the UE to perform an RLC retransmission in an uplink direction. In some aspects, the DU may receive, from the CU and based at least in part on a trigger, an indication of a PDCP reordering timer status or a request for an uplink resource assignment. The trigger may be based at least in part on a periodic timer expiry or an event trigger. The DU, when performing the action, may provide uplink resources for the UE, the bearer, or the logical channel based at least in part on an expected expiry of the PDCP reordering timer. The DU may trigger an RLC status report transmission to request the UE to perform an RLC retransmission in an uplink direction.

In some aspects, with respect to the fast RLC retransmission to avoid the PDCP reordering timer expiry, a PDCP layer may perform a packet reordering, and a PDCP t-reordering (timer) may be set to a value such that the RLC retransmission may be completed for the packet. However, the PDCP t-reordering may expire even before the RLC retransmission is finished (e.g., due to congestion). The DU may be unaware of PDCP t-reordering values configured in the CU, so the DU cannot guarantee to fulfill a PDCP SN gap before the PDCP t-reordering expiry.

In some aspects, assistance information may be used for the fast RLC retransmission to avoid the PDCP reordering timer expiry. The CU may share PDCP t-reordering information with the DU, such that the DU may control scheduling for a specific UE, bearer, or logical channel based at least in part on an associated status.

In some aspects, the CU may inform the DU of the PDCP t-reordering timer value used in the CU. The DU may maintain a PDCP timer status based at least in part on a received uplink PDCP PDU. When the PDCP timer is about to expire, the DU may start to provide more uplink resources with a specific UE, bearer, or logical channel. The DU may also trigger an RLC status report transmission to request the UE to perform the RLC retransmission in the uplink direction.

In some aspects, based at least in part on a trigger, the CU may inform the DU of a timer status, or the CU may request the DU for a larger uplink resource assignment. The trigger may be associated with a periodic timer expiry. The trigger may be an event trigger (e.g., a timer count has exceeded a certain threshold). The DU may maintain a PDCP timer status based at least in part on a received uplink PDCP PDU. When the PDCP timer is about to expire, the DU may start to provide more uplink resources with a specific UE, bearer, or logical channel. The DU may also trigger an RLC status report transmission to request the UE to perform the RLC retransmission in the uplink direction.

In some aspects, the assistance information may indicate the identification of the stream, the UE ID, the flow ID, the bearer ID, the RLC entity/channel/bearer ID, and/or the logical channel ID. The assistance information may indicate the cause value (e.g., the PDCP t-reordering is expected to expire).

In some aspects, the DU may receive the congestion related information from the CU or the other network node. The DU may receive the congestion related information based at least in part a trigger for sending the congestion related information. The congestion related information may indicate a PDCP discard occurrence in the uplink direction, congestion resolution information, and/or TCP ACKs transmitted in a downlink direction. The congestion related information may be transmitted in response to the packet discard. The congestion related information may be transmitted when a certain time period has elapsed from a time when a packet arrived in a UE buffer. The congestion related information may be transmitted based at least in part on a detection of an upper layer in recovering a packet loss through a slow-start or a duplicate ACK (DUPACK) recovery phase. The DU, when performing the action, may provide uplink resources for the UE, a bearer, or a logical channel based at least in part on the congestion related information.

In some aspects, with respect to the TCP packet drop, in a TCP congestion control, a TCP layer in a transmitting side may control an amount of packets transmitted, which may consider a receiving status based at least in part on feedback from a receiving side (e.g., selective ACK). When congestion is detected, the transmitting side may reduce the amount of packets (e.g., by shrinking the transmission window). Then, after the congestion is resolved, the transmitting side may start increasing the number of packets again, but this recovery phase may be subjected to delays, which may degrade a user experience.

In some aspects, assistance information may be used for the TCP packet drop. The DU may be informed, via the assistance information, of congestion related information. The assistance information may be provided, to the DU, by the CU, which may be based at least in part on detecting a PDCP t-reordering expiry or an explicit indication from the UE of a PDCP discarding, or by another network node (e.g., an application server). In some aspects, the assistance information may indicate the identification of the stream, the UE ID, the flow ID, the bearer ID, the RLC entity/channel/bearer ID, and/or the logical channel ID. The assistance information may indicate congestion related information (e.g., a PDCP discard occurrence in an uplink direction, congestion resolution information, and/or one or more TCP ACKs have been transmitted in a downlink direction). The assistance information may indicate a request for additional uplink resources. The assistance information may indicate the cause value (e.g., the PDCP t-reordering expiry).

In some aspects, the DU may receive the session control information from the CU or the other network node. The session control information may indicate an expected period of time to complete a session control procedure, an expected number of control packets to complete the session control procedure, and/or a cause value associated with a session start, a session resume, a session release, or a session termination. The DU, when performing the action, may provide uplink resources for the UE, a bearer, or a logical channel based at least in part on the session control information.

In some aspects, with respect to the application start phase, some applications may require a three-handshake procedure to establish, start, and/or resume a session. Since an application service may not start until the three-handshake procedure is completed, finishing the three-handshake procedure as early as possible may be preferred from a user point of view.

In some aspects, assistance information may be used for the application start phase. The DU may be informed, via the assistance information, of session control information in an upper layer (e.g., the application layer). The assistance information may be provided, to the DU, by the CU or by other network nodes (e.g., the application server). In some aspects, the assistance information may indicate the identification of the stream, the UE ID, the flow ID, the bearer ID, the RLC entity/channel/bearer ID, and/or the logical channel ID. The assistance information may indicate an expected period, or an expected number of packets (e.g., control packets) to finish a session control procedure. The assistance information may indicate a request for additional uplink resources. The assistance information may indicate the cause value (e.g., a session start, resume, release, or termination).

In some aspects, the DU may receive the RRC message information from the CU. The RRC message information may indicate an expected processing time of an RRC message, and/or an RRC message type. The DU, when performing the action, may provide, to the UE, an uplink grant to receive an RRC complete message. A timing to provide the uplink grant may be based at least in part on the expected processing time of the RRC message.

In some aspects, with respect to the uplink RRC message, an RRC processing time requirement for the UE may be defined for each RRC configuration contained in an RRC message. After the DU transmits a downlink RRC message, the DU may provide an uplink grant to receive the uplink RRC message (e.g., the RRC complete message) (without waiting for a scheduling request from the UE) to receive the uplink RRC message as early as possible. The DU may consider the RRC processing time requirement to determine the timing to provide the uplink grant.

In some aspects, assistance information may be used for the uplink RRC message. The DU may be informed, via the assistance information, of RRC message information. The assistance information may be provided, to the DU, by the CU. In some aspects, the assistance information may indicate the identification of the stream, the UE ID, the flow ID, the bearer ID, the RLC entity/channel/bearer ID, and/or the logical channel ID. The assistance information may indicate an expected processing time of the uplink RRC message and/or an RRC message type.

As indicated above, FIG. 9 is provided as an example. Other examples may differ from what is described with regard to FIG. 9.

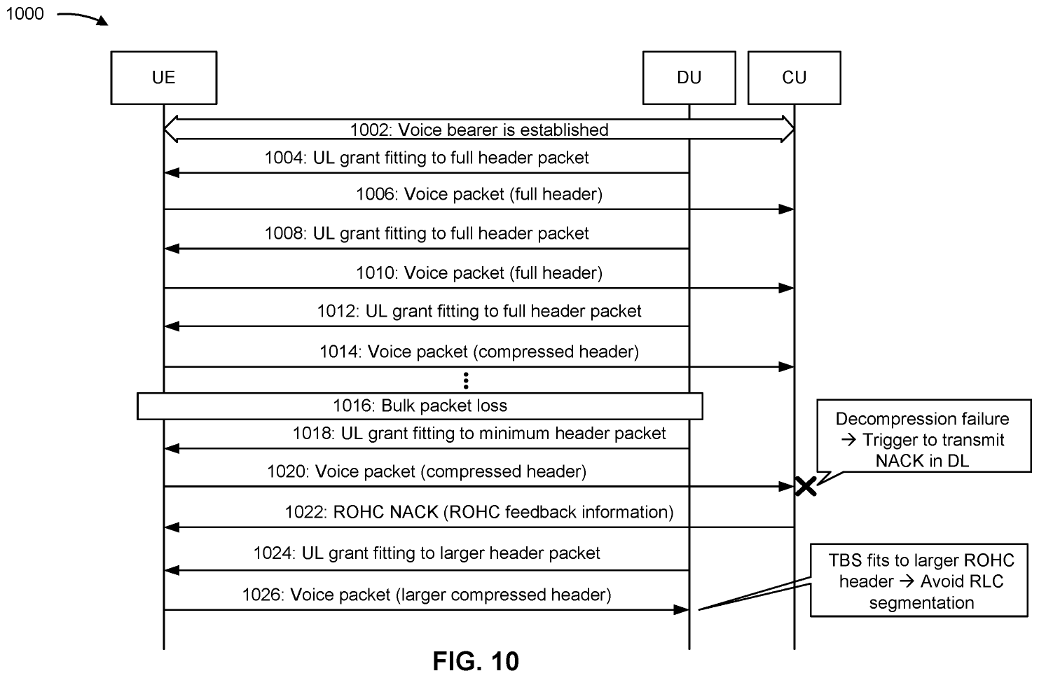

FIG. 10 is a diagram illustrating an example 1000 associated with assistance information for disaggregated network nodes, in accordance with the present disclosure. As shown in FIG. 10, example 1000 includes communication between the UE (e.g., UE 120) and a network node (e.g., network node 110). In some aspects, the UE and the network node may be included in a wireless network, such as wireless network 100. The network node may be a CU-DU split gNB. For example, the network node may include a DU and a CU.

As shown by reference number 1002, a voice bearer may be established between the UE and the CU. The DU may be configured to expect ROHC information from the CU, which may be achieved via a bearer setup procedure between the DU and the CU.

As shown by reference number 1004, the DU may transmit, to the UE, an uplink grant fitting to a full header packet. As shown by reference number 1006, the UE may transmit, to the CU, a voice packet with a full header. As shown by reference number 1008, the DU may transmit, to the UE, an uplink grant fitting to a full header packet. As shown by reference number 1010, the UE may transmit, to the CU, a voice packet with a full header. As shown by reference number 1012, the DU may transmit, to the UE, an uplink grant fitting to a minimum header packet. As shown by reference number 1014, the UE may transmit, to the CU, a voice packet with a compressed header.

As shown by reference number 1016, a bulk packet loss may occur between the UE and the DU. As shown by reference number 1018, the DU may transmit, to the UE, an uplink grant fitting to a minimum header packet. As shown by reference number 1020, the UE may transmit, to the CU, a voice packet with a compressed header. The CU may experience a decompression failure, which may cause the CU to be unable to decompress the compressed header. The decompression failure may trigger the CU to transmit a NACK in a downlink direction.

As shown by reference number 1022, the CU may transmit, to the UE via the DU, an ROHC NACK. The CU may transmit the ROHC NACK to the DU, and the DU may forward the ROHC NACK to the UE. The ROHC NACK may be associated with ROHC information. For example, the CU may transmit the ROHC NACK along with the ROHC information. The ROHC NACK may be transparent to the DU, but the ROHC information may be received and decoded by the DU. When the CU transmits downlink data to the DU, the CU may inform the DU whether a PDCP PDU includes the ROHC information (and feedback type) together with data or separately.

In some aspects, the ROHC information, as provided by the CU, may indicate an identity related to the UE, such as a UE ID, a EID, a quality of service (QOS) flow identifier (QFI), a bearer ID, a PDCP entity ID, an RLC entity ID, an RLC channel/bearer ID, and/or a logical channel ID. The ROHC information may indicate whether the downlink data is a PDCP data PDU or a PDCP control PDU. The ROHC information may indicate a PDCP control PDU type when the downlink data is the PDCP control PDU. The ROHC information may indicate a feedback type (e.g., ACK, NACK, or static NACK) and/or feedback contents. The ROHC information may indicate a timestamp. The ROHC information may indicate that an uplink packet size should be larger than a current size, an expected packet size, and/or a change of packet size. The ROHC information may be carried using an existing PDU format (e.g., NR user plane (U-plane) PDU type 0) or another PDU type.

As shown by reference number 1024, the DU may transmit, to the UE, an uplink grant fitting to a larger header packet, which may be based at least in part on the ROHC information. Otherwise, the DU would send an uplink grant fitting to a minimum header packet. Since the DU is indicated with the ROHC information, which may indicate the ROHC NACK, the DU may be able to adjust the uplink grant. When the DU detects the ROHC information, the DU may take the ROHC information into account when determining a TBS. For example, the DU may determine to use a larger TBS in a subsequent scheduling, which may result in the DU transmitting the uplink grant fitting to the larger header packet. In some aspects, the DU may use the larger TBS after a reception of the ROHC information from the CU. The DU may use the larger TBS after forwarding the ROHC information in a downlink direction. For example, the DU may use the larger TBS a certain amount of time after forwarding the ROHC information in the downlink direction. The DU may use the larger TBS after receiving a layer 1 (L1) or a layer 2 (L2) ACK for the ROHC information. For example, the DU may use the larger TBS a certain amount of time after receiving the L1/L2 ACK for the ROHC information.

As shown by reference number 1026, the UE may transmit, to the DU, a voice packet with a larger compressed header, in relation to the compressed header. The TBS may fit to a larger ROHC header, which may avoid an RLC segmentation.

In some aspects, the DU may be preemptively informed of an ROHC failure, such that the DU may allocate a larger grant in a next transmission to fit an uncompressed header. Otherwise, the DU may allocate a smaller grant (since the DU does not determine that the ROHC may be using a full header), which may force segmentation in an RLC layer and cause excessive delay and/or an underutilization of resources.

In some aspects, the CU may transmit the downlink data to the DU. The downlink data may be associated with an NR U-plane packet, which may be associated with PDU type 0. The NR U-plane packet may define an assistance information field, which may be for an uplink scheduling. The assistance information field may indicate whether the downlink data is the ROHC information (e.g., NACK or static NACK) and/or whether an uplink packet size may be changed. Thus, the downlink data may include the ROHC information in accordance with the existing PDU format (e.g., NR U-plane PDU type 0). In some aspects, a PDCP control PDU format may be used for interspersed ROHC feedback. For example, a format of the PDCP control PDU may be defined for carrying one interspersed ROHC feedback, which may be applicable for conveying the ROHC information from the CU to the DU.

In some aspects, when a compressor, which may be associated with the UE transmitting the compressed header, starts a compressed/smaller ROHC header, the compressor may ensure that a decompressor, which may be associated with the CU receiving the compressed header, receives sufficient information to establish or update an ROHC context. The compressor may ensure that the decompressor receives sufficient information by transmitting a sufficient number of packets with full/large ROHC headers. The sufficient number of packets with full/large ROHC headers may be useful for the DU to determine when to provide an uplink grant with a smaller TBS for compressed ROHC packets. Currently, the number of packets with full/large ROHC headers may not be visible to the DU because the number of packets with full/large ROHC headers may be based at least in part on a UE implementation.

In some aspects, the ROHC information may indicate ROHC parameter information in terms of a number of packets and/or a time period. For example, the ROHC information may indicate the number of packets with full/large ROHC headers and/or the time period associated with transmitting the packets with full/large ROHC headers. The ROHC information may include identity information, such as a UE ID, a tunneling endpoint identifier (TEID), a QFI, a bearer ID, a PDCP entity ID, an RLC entity ID, an RLC channel/bearer ID, and/or a logical channel ID. When the ROHC information may differ for different cases/states (e.g., an initial ROHC context establishment, an ROHC context update, an ROHC context resynchronization, or an ROHC context repair), such information may be provided to the DU as part of the ROHC information.

In some aspects, the UE may provide the ROHC information to the DU. A layer message may be considered, which may include an RRC layer message, an SDAP layer message, a PDCP layer message, an RLC layer message, a MAC layer message, or an L1 message. The UE may transmit the ROHC information periodically or in an event triggered manner (e.g., polling from the DU or a UE internal parameter update). The UE may be configured with a prohibit timer to avoid frequent signaling in an uplink direction. In some aspects, the CU may provide the ROHC information to the DU. The ROHC information may indicate static information, which may allow the CU to configure the UE with a value and then inform the DU of the value during a bearer setup procedure between the DU and the CU. The ROHC information may indicate dynamic information, which may allow the CU to observe a UE uplink ROHC behavior and then inform the DU of statistical information (e.g., a max value, an average value, and/or a minimum value, in terms of the number of packets and/or the time period). The CU may transmit the ROHC information periodically or in an event triggered manner (e.g., polling from the DU or the UE internal parameter update).

In some aspects, the ROHC information may be associated with a certain protocol, an F1 interface, an Xn interface, a Next Generation (NG) U-plane, and/or a general packet radio system (GPRS) tunnelling protocol user plane (GTP-U). In some aspects, the UE may transmit voice packets with headers in the uplink direction. Alternatively, the UE may transmit other types of packets configured with ROHC (e.g., an ROHC supported by an NR PDCP layer).

As indicated above, FIG. 10 is provided as an example. Other examples may differ from what is described with regard to FIG. 10.

FIG. 11 is a diagram illustrating an example process 1100 performed, for example, at a DU or an apparatus of a DU, in accordance with the present disclosure. Example process 1100 is an example where the apparatus or the DU (e.g., network node 110) performs operations associated with assistance information for disaggregated network nodes.

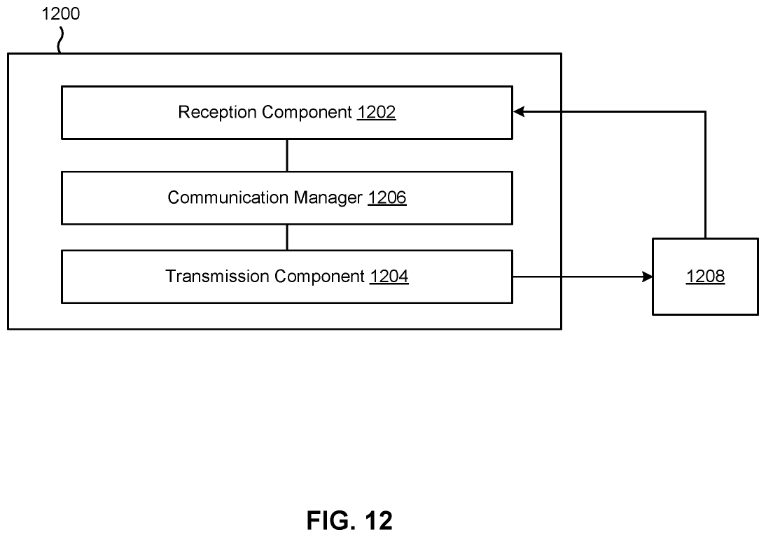

As shown in FIG. 11, in some aspects, process 1100 may include receiving, from one or more of a UE, a CU, or another network node, assistance information, wherein the assistance information indicates one or more of: ROHC information, uplink data related information, packet reordering timer information, congestion related information, session control information, or RRC message information (block 1110). For example, the DU (e.g., using reception component 1202 and/or communication manager 150, depicted in FIG. 12) may receive, from one or more of a UE, a CU, or another network node, assistance information, wherein the assistance information indicates one or more of: ROHC information, uplink data related information, packet reordering timer information, congestion related information, session control information, or RRC message information, as described above.

As shown in FIG. 11, in some aspects, process 1100 may include performing an action associated with the UE based at least in part on the assistance information (block 1120). For example, the DU (e.g., using communication component 1206 and/or communication manager 150, depicted in FIG. 12) may perform an action associated with the UE based at least in part on the assistance information, as described above.

Process 1100 may include additional aspects, such as any single aspect or any combination of aspects described below and/or in connection with one or more other processes described elsewhere herein.

In a first aspect, process 1100 includes transmitting, to the UE, an uplink grant indicating a TBS associated with a first header packet, in relation to an uplink grant indicating a TBS associated with a second header packet, based at least in part on the ROHC information.

In a second aspect, alone or in combination with the first aspect, process 1100 includes receiving, during a bearer setup procedure with the CU, a configuration associated with receiving the ROHC information.

In a third aspect, alone or in combination with one or more of the first and second aspects, the ROHC information indicates one or more of a feedback type including an ACK or a NACK, UE related identity information associated with the UE, an indication of whether downlink data is a PDCP data PDU or a PDCP control PDU, a PDCP control PDU type based at least in part on the downlink data being the PDCP control PDU, a timestamp, an indication of whether an uplink packet size will change, an expected uplink packet size, a difference of the uplink packet size from a previous uplink packet size, or a recommended TBS.

In a fourth aspect, alone or in combination with one or more of the first through third aspects, the ROHC information is associated with an NR user plane data PDU format.

In a fifth aspect, alone or in combination with one or more of the first through fourth aspects, the ROHC information indicates one or more of a number of packets transmitted with a specific ROHC header, a time period associated with the number of packets transmitted with the full ROHC header, or an indication of an applicability to an initial ROHC context establishment, an ROHC context update, an ROHC context resynchronization, or an ROHC context repair.

In a sixth aspect, alone or in combination with one or more of the first through fifth aspects, the ROHC information is received from the UE, the ROHC information is received in a periodic manner or in an event triggered manner, and the ROHC information is signaled in accordance with a prohibit timer.

In a seventh aspect, alone or in combination with one or more of the first through sixth aspects, the ROHC information is received from the CU, the ROHC information includes static information, the ROHC information includes dynamic information associated with a UE uplink ROHC behavior, and the dynamic information is received in a periodic manner or in an event triggered manner.

In an eighth aspect, alone or in combination with one or more of the first through seventh aspects, the ROHC information is associated with a voice packet or a non-voice packet configured with ROHC.

In a ninth aspect, alone or in combination with one or more of the first through eighth aspects, the assistance information indicates one or more of an identification of a stream, a UE ID, a flow ID, a bearer ID, an RLC entity ID, an RLC channel ID, an RLC bearer ID, or a logical channel ID.

In a tenth aspect, alone or in combination with one or more of the first through ninth aspects, the assistance information indicates one or more of a cause value associated with an expected expiry of a PDCP reordering timer, or a request for additional uplink resources.

In an eleventh aspect, alone or in combination with one or more of the first through tenth aspects, the uplink data related information is received from the UE, the CU, or the other network node, the uplink data related information is associated with multimedia traffic, and the uplink data related information indicates one or more of an expected periodicity of uplink data, an expected uplink data size, or a period of change to a periodicity of uplink data, and process 1100 includes receiving uplink data from the UE based at least in part on the uplink data related information.

In a twelfth aspect, alone or in combination with one or more of the first through eleventh aspects, process 1100 includes controlling a scheduling for the UE, a bearer, or a logical channel based at least in part on the packet reordering timer information, wherein the packet reordering timer information is associated with a MAC retransmission or an RLC retransmission to avoid an expiry of a PDCP reordering timer.

In a thirteenth aspect, alone or in combination with one or more of the first through twelfth aspects, the packet reordering timer information is received from the CU and includes a PDCP reordering timer value used by the CU, and process 1100 includes maintaining a PDCP reordering timer status based at least in part on a received uplink PDCP PDU, providing uplink resources for the UE, the bearer or the logical channel based at least in part on an expected expiry of the PDCP reordering timer, and triggering an RLC status report transmission to request the UE to perform an RLC retransmission in an uplink direction.

In a fourteenth aspect, alone or in combination with one or more of the first through thirteenth aspects, process 1100 includes receiving, from the CU and based at least in part on a trigger, an indication of a PDCP reordering timer status or a request for an uplink resource assignment, wherein the trigger is based at least in part on a periodic timer expiry or an event trigger, providing uplink resources for the UE, the bearer or the logical channel based at least in part on an expected expiry of the PDCP reordering timer, and triggering an RLC status report transmission to request the UE to perform an RLC retransmission in an uplink direction.

In a fifteenth aspect, alone or in combination with one or more of the first through fourteenth aspects, the congestion related information is received from the UE, the CU, or the other network node based at least in part on a trigger for sending the congestion related information, the congestion related information is received in response to one of: a packet discard, a certain time period having elapsed from a time when a packet arrived in a UE buffer, or a detection of an upper layer in recovering a packet loss through a slow-start or a duplicate ACK (DUPACK) recovery phase, and the congestion related information indicates one or more of: a PDCP discard occurrence in an uplink direction, congestion resolution information, or TCP ACKs transmitted in a downlink direction, and process 1100 includes providing uplink resources for the UE, a bearer, or a logical channel based at least in part on the congestion related information.

In a sixteenth aspect, alone or in combination with one or more of the first through fifteenth aspects, the session control information is received from the UE, the CU, or the other network node and indicates one or more of an expected period of time to complete a session control procedure, an expected number of control packets to complete the session control procedure, or a cause value associated with a session start, a session resume, a session release, or a session termination, and process 1100 includes providing uplink resources for the UE, a bearer, or a logical channel based at least in part on the session control information.

In a seventeenth aspect, alone or in combination with one or more of the first through sixteenth aspects, the RRC message information is received from the UE or the CU and indicates one or more of an expected processing time of an RRC message, or an RRC message type, and process 1100 includes providing, to the UE, an uplink grant to receive an RRC complete message, wherein a timing to provide the uplink grant is based at least in part on the expected processing time of the RRC message.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a DU, or a DU may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 9-10. Additionally, or alternatively, the apparatus 1200 may be configured to perform one or more processes described herein, such as process 1100 of FIG. 11. In some aspects, the apparatus 1200 and/or one or more components shown in FIG. 12 may include one or more components of the DU described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the DU described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the DU described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive, from one or more of a UE, a CU, or another network node, assistance information, wherein the assistance information indicates one or more of: ROHC information, uplink data related information, packet reordering timer information, congestion related information, session control information, or RRC message information. The communication manager 1206 may perform an action associated with the UE based at least in part on the assistance information.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a distributed unit (DU) of a network node, comprising: receiving, from one or more of a user equipment (UE), a central unit (CU) of the network node, or another network node, assistance information, wherein the assistance information indicates one or more of: robust header compression (ROHC) feedback information, uplink data related information, packet reordering timer information, congestion related information, session control information, or radio resource control (RRC) message information; and performing an action associated with the UE based at least in part on the assistance information.

Aspect 2: The method of Aspect 1, wherein performing the action comprises: transmitting, to the UE, an uplink grant indicating a transport block size (TBS) associated with a first header packet, in relation to an uplink grant indicating a TBS associated with a second header packet, based at least in part on the ROHC information.

Aspect 3: The method of any of Aspects 1-2, further comprising: receiving, during a bearer setup procedure with the CU, a configuration associated with receiving the ROHC information.

Aspect 4: The method of any of Aspects 1-3, wherein the ROHC information indicates one or more of: a feedback type including an acknowledgement (ACK) or a negative acknowledgement (NACK), UE related identity information associated with the UE, an indication of whether downlink data is a packet data convergence protocol (PDCP) data packet data unit (PDU) or a PDCP control PDU, a PDCP control PDU type based at least in part on the downlink data being the PDCP control PDU, a timestamp, an indication of whether an uplink packet size will change, an expected uplink packet size, a difference of the uplink packet size from a previous uplink packet size, or a recommended transport block size (TBS).

Aspect 5: The method of any of Aspects 1-4, wherein the ROHC information is associated with a New Radio (NR) user plane data packet data unit (PDU) format.

Aspect 6: The method of any of Aspects 1-5, wherein the ROHC information indicates one or more of: a number of packets transmitted with a specific ROHC header, a time period associated with the number of packets transmitted with the full ROHC header, or an indication of an applicability to an initial ROHC context establishment, an ROHC context update, an ROHC context resynchronization, or an ROHC context repair.

Aspect 7: The method of any of Aspects 1-6, wherein the ROHC information is received from the UE, the ROHC information is received in a periodic manner or in an event triggered manner, and the ROHC information is signaled in accordance with a prohibit timer.

Aspect 8: The method of any of Aspects 1-7, wherein the ROHC information is received from the CU, the ROHC information includes static information, the ROHC information includes dynamic information associated with a UE uplink ROHC behavior, and the dynamic information is received in a periodic manner or in an event triggered manner.

Aspect 9: The method of any of Aspects 1-8, wherein the ROHC information is associated with a voice packet or a non-voice packet configured with ROHC.

Aspect 10: The method of any of Aspects 1-9, wherein the assistance information indicates one or more of: an identification of a stream, a UE identifier (ID), a flow ID, a bearer ID, a radio link control (RLC) entity ID, an RLC channel ID, an RLC bearer ID, or a logical channel ID.

Aspect 11: The method of any of Aspects 1-10, wherein the assistance information indicates one or more of: a cause value associated with an expected expiry of a packet data convergence protocol (PDCP) reordering timer, or a request for additional uplink resources.

Aspect 12: The method of any of Aspects 1-11, wherein: the uplink data related information is received from the UE, the CU, or the other network node, the uplink data related information is associated with multimedia traffic, and the uplink data related information indicates one or more of an expected periodicity of uplink data, an expected uplink data size, or a period of change to a periodicity of uplink data, and performing the action comprises: receiving uplink data from the UE based at least in part on the uplink data related information.

Aspect 13: The method of any of Aspects 1-12, wherein performing the action comprises: controlling a scheduling for the UE, a bearer, or a logical channel based at least in part on the packet reordering timer information, wherein the packet reordering timer information is associated with a medium access control (MAC) retransmission or a radio link control (RLC) retransmission to avoid an expiry of a packet data convergence protocol (PDCP) reordering timer.

Aspect 14: The method of Aspect 13, wherein: the packet reordering timer information is received from the CU and includes a PDCP reordering timer value used by the CU; and performing the action comprises: maintaining a PDCP reordering timer status based at least in part on a received uplink PDCP packet data unit (PDU); providing uplink resources for the UE, the bearer or the logical channel based at least in part on an expected expiry of the PDCP reordering timer; and triggering an RLC status report transmission to request the UE to perform an RLC retransmission in an uplink direction.

Aspect 15: The method of Aspect 13, further comprising: receiving, from the CU and based at least in part on a trigger, an indication of a PDCP reordering timer status or a request for an uplink resource assignment, wherein the trigger is based at least in part on a periodic timer expiry or an event trigger; and performing the action comprises: providing uplink resources for the UE, the bearer or the logical channel based at least in part on an expected expiry of the PDCP reordering timer; and triggering an RLC status report transmission to request the UE to perform an RLC retransmission in an uplink direction.

Aspect 16: The method of any of Aspects 1-15, wherein: the congestion related information is received from the UE, the CU, or the other network node based at least in part on a trigger for sending the congestion related information, the congestion related information is received in response to one of: a packet discard, a certain time period having elapsed from a time when a packet arrived in a UE buffer, or a detection of an upper layer in recovering a packet loss through a slow-start or a duplicate ACK (DUPACK) recovery phase, and the congestion related information indicates one or more of: a packet data convergence protocol (PDCP) discard occurrence in an uplink direction, congestion resolution information, or transmission control protocol (TCP) acknowledgements (ACKs) transmitted in a downlink direction, and performing the action comprises: providing uplink resources for the UE, a bearer, or a logical channel based at least in part on the congestion related information.

Aspect 17: The method of any of Aspects 1-16, wherein: the session control information is received from the UE, the CU, or the other network node and indicates one or more of: an expected period of time to complete a session control procedure, an expected number of control packets to complete the session control procedure, or a cause value associated with a session start, a session resume, a session release, or a session termination; and performing the action comprises: providing uplink resources for the UE, a bearer, or a logical channel based at least in part on the session control information.

Aspect 18: The method of any of Aspects 1-17, wherein: the RRC message information is received from the UE or the CU and indicates one or more of: an expected processing time of an RRC message, or an RRC message type; and performing the action comprises: providing, to the UE, an uplink grant to receive an RRC complete message, wherein a timing to provide the uplink grant is based at least in part on the expected processing time of the RRC message.

Aspect 19: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-18.

Aspect 20: An apparatus for wireless communication at a device, the apparatus comprising one or more memories and one or more processors coupled to the one or more memories, the one or more processors configured to cause the device to perform the method of one or more of Aspects 1-18.

Aspect 21: An apparatus for wireless communication, the apparatus comprising at least one means for performing the method of one or more of Aspects 1-18.

Aspect 22: A non-transitory computer-readable medium storing code for wireless communication, the code comprising instructions executable by one or more processors to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

Aspect 24: A device for wireless communication, the device comprising a processing system that includes one or more processors and one or more memories coupled with the one or more processors, the processing system configured to cause the device to perform the method of one or more of Aspects 1-18.

Aspect 25: An apparatus for wireless communication at a device, the apparatus comprising one or more memories and one or more processors coupled to the one or more memories, the one or more processors individually or collectively configured to cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a distributed unit (DU) of a network node, comprising:
one or more memories; and
one or more processors coupled to the one or more memories, the one or more processors configured to cause the DU to:
receive, from one or more of a user equipment (UE), a central unit (CU) of the network node, or another network node, assistance information, wherein the assistance information indicates one or more of:
robust header compression (ROHC) feedback information,
uplink data related information,
packet reordering timer information,
congestion related information,
session control information, or
radio resource control (RRC) message information; and
perform an action associated with the UE based at least in part on the assistance information.

2. The apparatus of claim 1, wherein the one or more processors, to cause the DU to perform the action, are configured to cause the DU to:
transmit, to the UE, an uplink grant indicating a transport block size (TBS) associated with a first header packet, in relation to an uplink grant indicating a TBS associated with a second header packet, based at least in part on the ROHC information.

3. The apparatus of claim 1, wherein the one or more processors are further configured to cause the DU to:
receive, during a bearer setup procedure with the CU, a configuration associated with receiving the ROHC information.

4. The apparatus of claim 1, wherein the ROHC information indicates one or more of:
a feedback type including an acknowledgement (ACK) or a negative acknowledgement (NACK),
UE related identity information associated with the UE,
an indication of whether downlink data is a packet data convergence protocol (PDCP) data packet data unit (PDU) or a PDCP control PDU,
a PDCP control PDU type based at least in part on the downlink data being the PDCP control PDU,
a timestamp,
an indication of whether an uplink packet size will change,
an expected uplink packet size,
a difference of the uplink packet size from a previous uplink packet size, or
a recommended transport block size (TBS).

5. The apparatus of claim 1, wherein the ROHC information is associated with a New Radio (NR) user plane data packet data unit (PDU) format, and the ROHC information is associated with a voice packet or a non-voice packet configured with ROHC.

6. The apparatus of claim 1, wherein the ROHC information indicates one or more of:
a number of packets transmitted with a specific ROHC header,
a time period associated with the number of packets transmitted with the full ROHC header, or
an indication of an applicability to an initial ROHC context establishment, an ROHC context update, an ROHC context resynchronization, or an ROHC context repair.

7. The apparatus of claim 1, wherein the ROHC information is received from the UE, the ROHC information is received in a periodic manner or in an event triggered manner, and the ROHC information is signaled in accordance with a prohibit timer.

8. The apparatus of claim 1, wherein the ROHC information is received from the CU, the ROHC information includes static information, the ROHC information includes dynamic information associated with a UE uplink ROHC behavior, and the dynamic information is received in a periodic manner or in an event triggered manner.

9. The apparatus of claim 1, wherein the assistance information indicates one or more of:
an identification of a stream,
a UE identifier (ID),
a flow ID,
a bearer ID,
a radio link control (RLC) entity ID,
an RLC channel ID, an RLC bearer ID, or
a logical channel ID.

10. The apparatus of claim 1, wherein the assistance information indicates one or more of: a cause value associated with an expected expiry of a packet data convergence protocol (PDCP) reordering timer, or a request for additional uplink resources.

11. The apparatus of claim 1, wherein:
the uplink data related information is received from the UE, the CU, or the other network node, the uplink data related information is associated with multimedia traffic, and the uplink data related information indicates one or more of:
an expected periodicity of uplink data,
an expected uplink data size, or
a period of change to a periodicity of uplink data; and
the one or more processors, to cause the DU to perform the action, are configured to cause the DU to:
receive uplink data from the UE based at least in part on the uplink data related information.

12. The apparatus of claim 1, wherein the one or more processors, to cause the DU to perform the action, are configured to cause the DU to:
control a scheduling for the UE, a bearer, or a logical channel based at least in part on the packet reordering timer information, wherein the packet reordering timer information is associated with a medium access control (MAC) retransmission or a radio link control (RLC) retransmission to avoid an expiry of a packet data convergence protocol (PDCP) reordering timer.

13. The apparatus of claim 12, wherein:
the packet reordering timer information is received from the CU and includes a PDCP reordering timer value used by the CU; and
the one or more processors, to cause the DU to perform the action, are configured to cause the DU to:
maintain a PDCP reordering timer status based at least in part on a received uplink PDCP packet data unit (PDU);
provide uplink resources for the UE, the bearer or the logical channel based at least in part on an expected expiry of the PDCP reordering timer; and
trigger an RLC status report transmission to request the UE to perform an RLC retransmission in an uplink direction.

14. The apparatus of claim 12, wherein the one or more processors are further configured to cause the DU to:
receive, from the CU and based at least in part on a trigger, an indication of a PDCP reordering timer status or a request for an uplink resource assignment, wherein the trigger is based at least in part on a periodic timer expiry or an event trigger; and
the one or more processors, to cause the DU to perform the action, are configured to cause the DU to:
provide uplink resources for the UE, the bearer or the logical channel based at least in part on an expected expiry of the PDCP reordering timer; and
trigger an RLC status report transmission to request the UE to perform an RLC retransmission in an uplink direction.

15. The apparatus of claim 1, wherein:
the congestion related information is received from the UE, the CU, or the other network node based at least in part on a trigger for sending the congestion related information, and the congestion related information indicates one or more of: a packet data convergence protocol (PDCP) discard occurrence in an uplink direction, congestion resolution information, or transmission control protocol (TCP) acknowledgements (ACKs) transmitted in a downlink direction, and
the one or more processors, to cause the DU to perform the action, are configured to cause the DU to:
provide uplink resources for the UE, a bearer, or a logical channel based at least in part on the congestion related information.

16. The apparatus of claim 15, wherein the congestion related information is received in response to one of: a packet discard, a certain time period having elapsed from a time when a packet arrived in a UE buffer, or a detection of an upper layer in recovering a packet loss through a slow-start or a duplicate ACK (DUPACK) recovery phase.

17. The apparatus of claim 1, wherein:
the session control information is received from the UE, the CU, or the other network node and indicates one or more of:
an expected period of time to complete a session control procedure,
an expected number of control packets to complete the session control procedure, or
a cause value associated with a session start, a session resume, a session release, or a session termination; and
the one or more processors, to cause the DU to perform the action, are configured to cause the DU to:
provide uplink resources for the UE, a bearer, or a logical channel based at least in part on the session control information.

18. The apparatus of claim 1, wherein:
the RRC message information is received from the CU and indicates one or more of:
an expected processing time of an RRC message, or
an RRC message type; and
the one or more processors, to cause the DU to perform the action, are configured to cause the DU to:
provide, to the UE, an uplink grant to receive an RRC complete message, wherein a timing to provide the uplink grant is based at least in part on the expected processing time of the RRC message.

19. A method of wireless communication performed by a distributed unit (DU) of a network node, comprising:
receiving, from one or more of a user equipment (UE), a central unit (CU) of the network node, or another network node, assistance information, wherein the assistance information indicates one or more of:
robust header compression (ROHC) feedback information,
uplink data related information,
packet reordering timer information,
congestion related information,
session control information, or
radio resource control (RRC) message information; and
performing an action associated with the UE based at least in part on the assistance information.

20. The method of claim 19, wherein performing the action comprises:
transmitting, to the UE, an uplink grant indicating a transport block size (TBS) associated with a first header packet, in relation to an uplink grant indicating a TBS associated with a second header packet, based at least in part on the ROHC information.

21. The method of claim 19, wherein the ROHC information indicates one or more of:
a feedback type including an acknowledgement (ACK) or a negative acknowledgement (NACK),
UE related identity information associated with the UE,
an indication of whether downlink data is a packet data convergence protocol (PDCP) data packet data unit (PDU) or a PDCP control PDU,
a PDCP control PDU type based at least in part on the downlink data being the PDCP control PDU,
a timestamp,
an indication of whether an uplink packet size will change,
an expected uplink packet size,
a difference of the uplink packet size from a previous uplink packet size, or
a recommended transport block size (TBS).

22. The method of claim 19, wherein the ROHC information indicates one or more of:
a number of packets transmitted with a specific ROHC header,
a time period associated with the number of packets transmitted with the full ROHC header, or
an indication of an applicability to an initial ROHC context establishment, an ROHC context update, an ROHC context resynchronization, or an ROHC context repair.

23. The method of claim 19, wherein:
the ROHC information is received from the UE, the ROHC information is received in a periodic manner or in an event triggered manner, and the ROHC information is signaled in accordance with a prohibit timer;
the ROHC information is received from the CU, the ROHC information includes static information, the ROHC information includes dynamic information associated with a UE uplink ROHC behavior, and the dynamic information is received in a periodic manner or in an event triggered manner; or
the ROHC information is associated with a voice packet or a non-voice packet configured with ROHC.

24. The method of claim 19, wherein:
the uplink data related information is received from the UE, the CU, or the other network node, the uplink data related information is associated with multimedia traffic, and the uplink data related information indicates one or more of:
an expected periodicity of uplink data,
an expected uplink data size, or
a period of change to a periodicity of uplink data; and
performing the action comprises:
receiving uplink data from the UE based at least in part on the uplink data related information.

25. The method of claim 19, wherein performing the action comprises:
controlling a scheduling for the UE, a bearer, or a logical channel based at least in part on the packet reordering timer information, wherein the packet reordering timer information is associated with a medium access control (MAC) retransmission or a medium access control (MAC) retransmission or a radio link control (RLC) retransmission to avoid an expiry of a packet data convergence protocol (PDCP) reordering timer.

26. The method of claim 25, wherein:
the packet reordering timer information is received from the CU and includes a PDCP reordering timer value used by the CU; and
performing the action comprises:
maintaining a PDCP reordering timer status based at least in part on a received uplink PDCP packet data unit (PDU);
providing uplink resources for the UE, the bearer or the logical channel based at least in part on an expected expiry of the PDCP reordering timer; and
triggering an RLC status report transmission to request the UE to perform an RLC retransmission in an uplink direction.

27. The method of claim 25, further comprising:
receiving, from the CU and based at least in part on a trigger, an indication of a PDCP reordering timer status or a request for an uplink resource assignment, wherein the trigger is based at least in part on a periodic timer expiry or an event trigger; and
performing the action comprises:
providing uplink resources for the UE, the bearer or the logical channel based at least in part on an expected expiry of the PDCP reordering timer; and
triggering an RLC status report transmission to request the UE to perform an RLC retransmission in an uplink direction.

28. The method of claim 19, wherein:
the congestion related information is received from the UE, the CU, or the other network node based at least in part on a trigger for sending the congestion related information, the congestion related information is received in response to one of: a packet discard, a certain time period having elapsed from a time when a packet arrived in a UE buffer, or a detection of an upper layer in recovering a packet loss through a slow-start or a duplicate ACK (DUPACK) recovery phase, and the congestion related information indicates one or more of: a packet data convergence protocol (PDCP) discard occurrence in an uplink direction, congestion resolution information, or transmission control protocol (TCP) acknowledgements (ACKs) transmitted in a downlink direction, and
performing the action comprises:
providing uplink resources for the UE, a bearer, or a logical channel based at least in part on the congestion related information.

29. A non-transitory computer-readable medium storing a set of instructions for wireless communication, the set of instructions comprising:
one or more instructions that, when executed by one or more processors of a distributed unit (DU) of a network node, cause the DU to:
receive, from one or more of a user equipment (UE), a central unit (CU) of the network node, or another network node, assistance information, wherein the assistance information indicates one or more of:
robust header compression (ROHC) feedback information,
uplink data related information,
packet reordering timer information,
congestion related information,
session control information, or
radio resource control (RRC) message information; and
performing an action associated with the UE based at least in part on the assistance information.

30. An apparatus for wireless communication, comprising:
means for receiving, from one or more of a user equipment (UE), a central unit (CU), or another network node, assistance information, wherein the assistance information indicates one or more of:
robust header compression (ROHC) feedback information,
uplink data related information,
packet reordering timer information,
congestion related information,
session control information, or
radio resource control (RRC) message information; and
performing an action associated with the UE based at least in part on the assistance information.
